(19) United States
(12) Patent Application Publication
(10) Pub. No.: US 2011/0278203 A1
(43) Pub. Date: Nov. 17, 2011

(54) SEPARATION OF PARTICLES FROM A FLOWING STREAM

(75) Inventors: Mark G. Raizen, Austin, TX (US); Melissa Jerkins, Austin, TX (US); Isaac Chavez, Austin, TX (US); Uzi Even, Tel Aviv (IL)

(73) Assignee: BOARD OF REGENTS, THE UNIVERSITY OF TEXAS SYSTEM, Austin, TX (US)

(21) Appl. No.: 12/941,823

(22) Filed: Nov. 8, 2010

Related U.S. Application Data
(60) Provisional application No. 61/259,182, filed on Nov. 8, 2009.
(60) Provisional application No. 61/331,563, filed on May 5, 2010.

(51) Int. Cl. B03C 1/02; B03C 1/005

(52) U.S. Cl. 209/3.1

(57) ABSTRACT

This invention provides a process for separating particles. The process is particularly effective in separating particles such as isotopes of a chemical element. In carrying out the process, at least one particle stream that comprises the particles that are to be separated is contacted with a separate carrier gas stream to produce a mixed stream. A portion of the particles in the mixed stream is magnetically activated, and the magnetically activated particles are separated from non-magnetically activated particles the mixed stream.

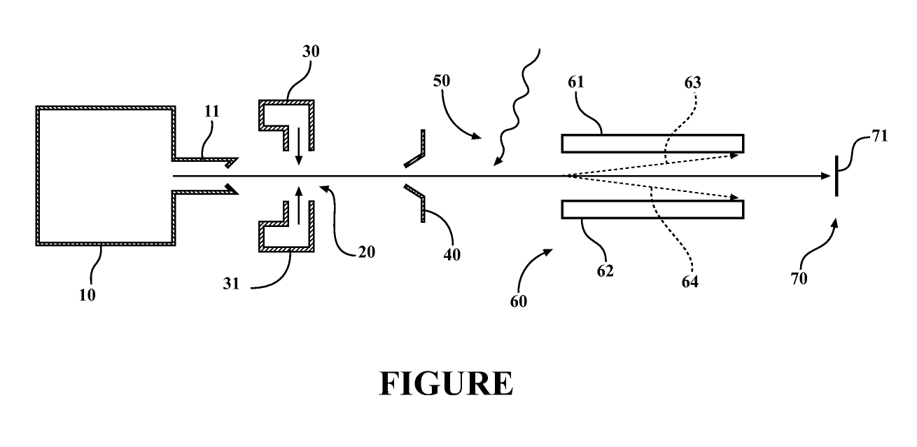

### CROSS REFERENCE TO RELATED APPLICATIONS

This application claims the benefit of the filing dates of U.S. Ser. No. 61/259,182, filed Nov. 8, 2009, and U.S. Ser. No. 61/331,563, filed May 5, 2010, the contents of each being fully incorporated herein by reference.

### FIELD OF THE INVENTION

This invention relates to separating particles from a flowing stream. In particular, this invention relates to separation of isotope particles of the same element from a flowing stream containing the particles.

### BACKGROUND OF THE INVENTION

Particle separation processes have been incorporated into a wide variety of technologies. The processes can significantly differ depending upon the characteristics of the particles being separated.

Separation of particles such as isotopes of the same chemical element has been a particular challenge. Processes used to separate these particular types of particles also vary significantly. For example, some separation processes use centrifugal forces to separate particles having differences in density. Other separation processes use magnetic forces to separate particles having differences in responses to the applied magnetic forces.

U.S. Pat. No. 5,443,702 discloses a method for separating isotopes of erbium. In general, the method involves using an electron gun to heat a crucible containing liquid metal (or alloy) and vaporize the erbium. The stream of vapor is passed through a photoionization zone, where the vapor is exposed to laser beams of predetermined energy and frequency. The laser beams selectively photoionize isotopes in the vapor, and the ions are withdrawn from the vapor by an applied electromagnetic field.

U.S. Pat. No. 7,323,651 discloses a method for isotope separation of thallium. A thallium atomic beam is generated by heating thallium at a temperature between 800-1000° C. using a thermal heater. The beam is collimated by an atomic beam collimator, and the collimated beam is optically and isotope-selectively pumped into a metastable state by a CW laser. The optically pumped thallium isotopes are then photoionized by a pulsed UV laser and a pulsed IR laser. Photoionized thallium ions and electrons generated during the photoionization are separated from the atomic beam by an extractor, biased by an external electric field.

U.S. Pat. No. 6,559,402 discloses a process of separating low natural concentration protons in an electromagnetic separator. The process includes placing a working substance of a separated element in a crucible, heating the working substance, and ionizing the vapors that are produced by hot cathode electron emission. A beam of this ionized vapor is shaped by electrodes of an ion-optical system, and the ions separated in a magnetic field. The desired ions are then captured in a receiver.

U.S. Pat. No. 4,368,387 discloses a method for separating isotopes of an element having isotopes of higher and lower magnetic moments. The method includes a step of providing a solution stream containing particles in which each particle contains only one atom of the element the isotopes of which are to be separated. The stream is passed through a mass of finely divided discrete bodies having high magnetic susceptibility, and a high intensity magnetic field is applied to the mass while the stream is passed through the mass to retard the passage of the isotope of higher magnetic moment. After passing the fluid through the magnetized mass, it is directed into a first vessel. Application of the magnetic field to the mass is discontinued while maintaining the flow of the stream. The flow of the stream from the demagnetized mass is directed into a second vessel for a period sufficient to flush the isotope of higher magnetic moment therefrom and to collect such isotope in the second vessel.

U.S. Pat. No. 4,105,921 discloses a method for separating gas molecules containing one isotope of an element from gas molecules containing other isotopes of the same element in which all of the molecules of the gas are at the same electronic state in their ground state. Gas molecules in a gas stream containing one of the isotopes are selectively excited to a different electronic state while leaving the other gas molecules in their original ground state. Gas molecules containing one of the isotopes are then deflected from the other gas molecules in the stream and thus physically separated.

The particular particle separation methods are relatively complex and highly dependent upon the type of feed material that is being used. What is generally desired is a more effective and efficient means of achieving particle separation. In particular, more effective and efficient means of separating particles from solid materials, such as isotopes of materials that are considered solid elements at standard conditions, are desired.

### SUMMARY OF THE INVENTION

This invention provides a highly effective and efficient process for separating particles. The invention is particularly effective in separating particles such as isotopes from a wide variety of feed material. The feed material that can be used is generally any elemental material that is a solid a standard conditions.

According to one aspect of the invention, there is provided, a process for separating particles. Steps of the process include providing at least one particle stream and contacting at least a portion the particles in the particle stream with a carrier gas stream to produce a mixed stream containing the particles and the carrier gas.

A portion of the particles in the mixed stream are magnetically activated in the process. At least a portion of the magnetically activated particles is then separated from the mixed stream.

The provided particle stream is produced by vaporizing a feed material. The feed material is a solid material at 0° C. and 1 atmosphere.

According to an alternative aspect of the invention, there is provided a process for separating particles in which a feed material is vaporized to form at least one particle stream containing particles capable of being magnetically activated and particles not capable of being magnetically activated. At least a portion the particles in the particle stream is contacted with a separate carrier gas stream to produce a mixed stream containing the particles and the carrier gas. At least a portion of the particles in the mixed stream that are capable of being magnetically activated is magnetically activated, and at least a portion of the magnetically activated particles are separated from non-magnetically activated particles in the mixed stream.

The particles are particles of at least one element having a nuclear number of at least 6 according to the Periodic Table of the Elements. In general, the particles are comprised of at least two isotopes of one element of the Periodic Table, with at least one of the isotopes being susceptible to magnetic activation and at least one isotope not being susceptible to magnetic activation.

In one embodiment of the invention, the particle stream has a particle density of at least 10⁵ particles/m³, based on total volume of the particle stream prior to contacting the carrier gas stream.

In another embodiment, at least two particle streams are provided and at least a portion each particle stream contacts the carrier gas to produce the mixed gas stream. The feed material can be vaporized in at least two different vessels in which at least two particle streams are produced. In this embodiment, the two particle streams contact the carrier gas stream to produce the mixed gas stream. The particle streams can be ejected from their respective vessels in countercurrent direction, such as in a perpendicular orientation relative to the direction of flow of the carrier gas stream.

In a particular embodiment of the invention, the carrier gas stream is comprised of inert gas. The inert gas preferably comprises at least one noble gas.

The carrier gas stream is supplied from a pressure vessel. Preferably, the carrier gas stream is supplied from a pressure vessel at a pressure of at least 100 kPa.

The pressure vessel will include some sort of aperture through which the carrier gas stream will be ejected. Preferably, the pressure vessel includes an aperture of from 10 μm to 1,000 μm in diameter, through which the carrier gas is ejected.

The particles of the particle stream are contacted with a carrier gas stream to produce the mixed stream in a contact zone at a pressure of less than one atmosphere. Optionally, the mixed stream is further treated to increase collimation of the components of the mixed stream as the mixed stream flows downstream.

### BRIEF DESCRIPTION OF THE DRAWINGS

An example of a preferred embodiment of this invention is shown in the attached FIGURE, wherein the FIGURE is a simple process flow diagram demonstrating the steps of the overall process.

### DETAILED DESCRIPTION OF THE INVENTION

### Introduction

This invention provides a process for separating particles. The process is particularly effective in separating particles such as isotopes, and the process is effective for separating isotopes of a significant number, if not all, of the elements listed in the Periodic Table of the Elements.

According to one aspect of the invention, at least one particle stream that comprises the particles that are to be separated is provided. At least a portion the particles in the particle stream is contacted with a separate carrier gas stream to produce a mixed stream. In other words, two separate streams, a particle stream and a carrier gas stream, are effectively combined to produce a mixed stream. A portion of the particles in the mixed stream is then magnetically activated, and the magnetically activated particles are separated from the mixed stream. Particles that are non-magnetically activated in the mixed stream will remain with the mixed stream.

Particle Stream Characteristics

The provided particle stream can be produced by vaporizing a feed material. The feed material used in this invention is generally a solid material at 0° C. and 1 atmosphere.

The feed material is vaporized in a vessel at a temperature of not less than 0° C. Preferably, the feed material is vaporized in a vessel at a temperature of not less than 10° C., more preferably not less than 100° C., and most preferably not less than 1000° C.

The vessel in which the feed material is vaporized is maintained at a relatively low pressure during vaporization. Ideally, the feed material is vaporized in a vessel at a pressure of not greater than 50,000 Pa. Preferably, the feed material is vaporized in a vessel at a pressure of not greater than 5,000 Pa, more preferably not greater than 500 Pa, even more preferably not greater than 50 Pa and most preferably not greater than 5 Pa.

Only a portion of the particles in the particle stream is capable of being magnetically activated or is magnetically activated. In a preferred embodiment in which the particles are representative of a mixture of isotopes of an element, only certain isotopes will preferably be capable of magnetic activation, whereas other isotopes in the mixture will not be.

Magnetically activated particles according to this invention are particles that have been altered so as to be susceptible to a magnetic field. This can occur, for example, by applying energy that is effective in altering the magnetic moment to mass ratio of the particles such that the direction of flow of a stream of the magnetically activated particles can be altered by the application of the energy. Such energy can generally be referred to as magnetic energy or magnetic force, but this type of energy is also intended to include any aspect of magnetic force such as electromagnetic energy.

In one embodiment of the invention, the particles are particles of at least one element having a nuclear number of at least 6 according to the Periodic Table of the Elements. Preferably, the particles are comprised of at least two isotopes of one element of the Periodic Table, with at least one of the isotopes being susceptible to magnetic activation and at least one isotope not being susceptible to magnetic activation.

This invention is particularly effective with regard to separating particles or isotopes of elements selected from Group 1, Group 2, Group 3, Group 4, Group 6, Group 8, Group 10, Group 11, Group 12, Group 13, Group 14, Group 15 and the Lanthanides Series, as defined according to the IUPAC System designation of elements in the Periodic Table of the Elements.

Particularly preferred elements of Group 1 include K and Rb; Group 2 include Mg, Ca, Sr and Ba; Group 3 includes La; Group 4 include Zr and Hf; Group 5 includes V; Group 6 include Cr and Mo; Group 8 include Fe and Ru; Group 10 include Ni, Pd and Pt; Group 11 include Cu and Ag; Group 12 include Zn and Cd; Group 13 include Ga, In and Tl; Group 14 include Ge, Sn and Pb; Group 15 include Se and Te; and the Lanthanides Series include Ce, Nd, Sm, Eu, Gd, Dy, Er, Yb and Lu.

The particle stream should be provided at a flow rate that is sufficient to provide sufficient particles for inclusion or entrainment in the mixed stream, as well as maintain the desired qualities of the carrier gas stream within the mixed stream. The particle stream is provided at a flow rate of at least 10¹⁴ particles per second, preferably from 10¹⁴ to 10²² particles per second, more preferably from 10¹⁶ to 10²⁰ particles per second, and alternatively from 10¹⁷ to 10¹⁹ particles per second, base on the number of particles in the particle stream that contacts the carrier gas stream.

The particle steam should also have a density this is sufficient for effective separation. Generally, the particle stream has a particle density of at least 10⁵ particles/m³. Preferably, the particle stream has a particle density of at least 10¹⁰ particles/m³, more preferably at least 10¹⁵ particles/m³, and most preferably at least 10²⁰ particles/m³, based on total volume of the particle stream prior to contacting the carrier gas stream.

At least one particle stream is provided. In a particular embodiment, at least two particle streams are provided, and at least a portion of each particle stream contacts the carrier gas to produce the mixed gas stream.

The feed material can be vaporized in any vessel suitable for vaporization. The vessel is made of a material that has a higher melting point than the feed material, and does not react chemically with the feed material at elevated temperatures. For example, K, Rb, Mg, Ca, Sr, and Ba can be heated in a stainless steel vessel. Feed material with higher melting points, such as Pt, can be vaporized in vessels made of tantalum or carbon, for example.

The feed material can be vaporized in one or more vessels and the particle streams produced from vaporization then mixed with the carrier gas stream. In one embodiment, the feed material is vaporized in at least two different vessels in which at least two particle streams are produced. The two particle streams then contact the carrier gas stream to produce the mixed gas stream.

In the embodiment in which more than one particle stream is provided, the particle streams are provided by ejecting the streams from their respective vessels in countercurrent direction. In a particularly preferred embodiment, the particle streams are ejected from their respective vessels in countercurrent direction, with the ejection paths being diametrically opposed to one another. The particle streams are most effectively arranged in a perpendicular orientation relative to the direction of flow of the carrier gas stream.

The vessels or ovens from which the particle streams are produced can also be aligned across from one another so that when the particle streams are ejected from their respective vessels, particles that pass through the carrier gas stream and do not become part of the mixed stream can be caught by the opposing vessel and pushed back in the countercurrent direction when the opposing vessel is in operation mode.

Carrier Gas Stream Characteristics

The carrier gas stream is comprised of inert gas. An inert gas according to this invention is considered a gas that is substantially unreactive with the particles.

The inert gas is preferably comprised of at least one noble gas. Examples of noble gases include helium, neon, argon, krypton, xenon and radon. Preferred noble gases include helium, neon, argon, krypton and xenon.

The carrier gas stream should flow at a rate sufficient to entrain the particles in a manner that is effective for magnetic activation of a portion of the particles in the particle stream and that is effective in separating those particles downstream of the contact zone of the particle stream with the carrier gas stream. In particular, the carrier gas stream is maintained at a flow rate that optimizes directionality of the stream. Preferably, the carrier gas stream flows at a rate, i.e., has a mean flow rate, of at least 250 m/s, and more preferably at least 500 m/s. The carrier gas stream preferably flows at a rate, i.e., a mean flow rate, of not greater than 2,500 m/s, and more preferably not greater than 2,000 m/s. Alternatively, the carrier gas stream is at a flow rate of from 500 m/s to 2,000 m/s, such as from 750 ms/ to 1,500 m/s.

The carrier gas stream can be ejected from the pressure vessel in continuous or pulsed mode. Preferably, the carrier gas stream is ejected from the pressure vessel in continuous mode.

The flow rate of the carrier gas stream should not vary significantly so as to ensure efficient separation of particles downstream. Preferably, the carrier gas stream has a velocity spread that is not greater than 5%, more preferably not greater than 2% of its mean flow rate.

The carrier gas stream is supplied from a pressure vessel in order to generate the desired flow rate and directionality of the stream. Preferably, the pressure vessel is at a pressure of at least 100 kPa, more preferably at least 200 kPa, still more preferably at least 500 kPa and most preferably at least 750 kPa.

In order to better align and generate the proper flow rate of the carrier gas, the pressure vessel includes an appropriately sized aperture through which the carrier gas is ejected. Preferably, the pressure vessel includes an aperture of from 10 μm to 1,000 μm in diameter, more preferably from 20 μm to 800 μm in diameter, and most preferably from 40 μm to 600 μm in diameter, through which the carrier gas is ejected.

The pressure vessel and aperture are also operated and designed so as to have a limited angular divergence of the carrier gas stream as it is ejected from the pressure vessel and travels downstream. The carrier gas stream desirably has an angular divergence of not greater than 15°, preferably not greater than 10°, more preferably not greater than 5°.

The carrier gas stream also has a density that is effective for separation of the particles in the particle stream. Preferably, the carrier gas stream is ejected from the pressure vessel at a density of at least 10⁵ atoms/m³, preferably at least 10¹⁰ atoms/m³, more preferably at least 10¹⁵ atoms/m³, and most preferably at least 10²⁰ atoms/m³, based on total volume of the carrier gas stream ejected from the pressure vessel.

The carrier gas stream also has a flux characteristic that is effective for separation of the particles in the particle stream. Preferably, the carrier gas stream is ejected from the pressure vessel at a flux of at least 10⁵ atoms/sr/sec, preferably at least 10¹⁰ atoms/sr/sec, more preferably at least 10¹⁵ atoms/sr/sec, and most preferably at least 10²⁰ atoms/sr/sec.

The pressure vessel is at a temperature that aids in generating the desired flow rate and directionality of the stream. For example, a suitable temperature can be from 0° C. to 100° C.

Mixed Stream Characteristics

The particle stream and carrier gas stream contact one another in a contact zone to produce the mixed stream. In essence, at least a substantial portion of the particles in the particle stream becomes entrained with at least a significant portion of the carrier gas stream to produce the mixed stream. The mixed stream is further treated to magnetically activate a portion of the particles and the particles later separated.

In the embodiment in which at least two particle streams are provided, contact with the carrier gas is also made in the contact zone to produce the mixed gas stream. This includes the embodiment in which the particle streams are ejected from their respective vessels in countercurrent direction.

The contact zone is at a pressure of less than one atmosphere. Preferably, the contact zone is at a pressure of not greater than 100 kPa, more preferably not greater than 1 kPa, still more preferably not greater than 1,000 Pa, yet more preferably not greater than 10 Pa, still more preferably not greater than 0.1 Pa, and most preferably not greater than 0.01 Pa.

The particle stream and the carrier gas stream contact each other at relative flows to ensure appropriate entrainment of particles in the carrier gas stream so as to form a mixed stream having the appropriate characteristics to achieve particle separation downstream of the flow of the contact zone. Preferably, the particle stream and the carrier gas stream contact each other at a volumetric flow ratio of at least 1:100, more preferably at least 1:50, most preferably at least 1:20.

Mixed Stream Treatment to Increase Collimation

The mixed stream can be further treated, if desired, to increase collimation, i.e., reduce divergence of the components of the mixed stream, as the mixed stream flows downstream for further processing. Any suitable means for increasing collimation of components of a flowing stream can be used. Such a means includes, for example, passing the mixed stream through a collimator such as one or more apertures, known as skimmers, which can act to reduce or diffract portions of the mixed stream that are tending to diverge from a relatively straight moving path and would tend to disrupt the desired path of the mixed stream as it flows downstream.

If desired, the mixed stream can be treated to increase collimation by at least 10%, or at least 50%. The amount of treatment can be adjusted as necessary as long as there is minimal disruption to the amount of particles in the mixed stream as well as minimal disruption of the desired flow path of the mixed stream in the downstream direction.

Magnetically Activating the Particles

As the mixed stream flows down the path toward its intended target, and further treated to increase collimation if desired, energy is applied to the mixed stream to magnetically activate a portion of the particles in the mixed stream. The amount of particles that can be activated depends upon the amount of particles in the mixed stream that are capable of being magnetically activated relative to the total number of particles in the mixed stream. For example, when Ca is the feed material that is vaporized to produce the particle stream, the particle stream will naturally include Ca-48 as a particle or isotope that can be magnetically activated. The Ca-48 isotope is low in abundance, and will likely be included in a low concentration in the mixed stream, such at a concentration of approximately 0.2% of the total volume of the mixed stream.

This process can be effectively carried out on mixed streams that incorporate very low concentrations of particles that can be magnetically activated. The mixed stream should contain at least 1 ppm, or at least 5 ppm, or at least 10 ppm, of particles that can be magnetically activated, based on total weight of particles in the mixed stream.

The energy that is applied to the mixed stream to activate the portion of the particles that are capable of being magnetically activated can be considered electromagnetic wave energy. For effective, yet efficient activation, the electromagnetic wave energy that is applied should be not greater than 5 photons per activated particle, i.e., atomic particle. More efficiently, the applied energy is not greater than 4 photons or 3 photons per particle, in which a photon of energy is considered to be in the general range of 3-6 electron-Volts. Therefore, the applied energy is preferably not greater than 30 electron-Volts per activated particle, or not greater than 15 electron-Volts per particle.

Any means suitable for applying the appropriate amount of energy needed to activate the particles capable of being magnetically activated can be used. Examples of such means include, but are not limited to, lasers, lamps or light emitting diodes.

Separating the Particles with Magnetic Field Separation

The magnetically activated particles within the magnetically activated mixed stream are separated using a magnetic or electric system effective to displace the magnetically activated particles as the mixed stream flows through the separation section. As the mixed stream flows through this magnetic field in the separation section, the non-magnetically activated particles will remain flowing in the path of the mixed stream, while the magnetically activated particles will be displaced toward the direction from which the magnetic field emanates.

In one embodiment, a magnetic field for separating the magnetically activated particles from the mixed stream is applied in the form of a tube, with a minimum field portion being applied along a central axis of the tube and a radial gradient increasing in magnitude as distance from the central axis is increased. Preferably, the magnetic field along the axis is relatively constant. Any type of magnet suitable for applying the desired magnetic field can be used, such as a permanent magnet or an electromagnet.

Collecting the Particles

The portion of the particles that is not magnetically activated will pass through the applied magnetic field in the separation section with little if any effect on those particles by the magnetic field as those particles flow along with the mixed stream. These particles pass through the separation section or magnetic field region and are collected in a collection zone downstream of the magnetic field region. These particles can be collected using any appropriate means. Examples of such means include a metal collection plate or metal vessel. Preferably, the collection zone is at a temperature that is less than the melting point temperature of the particles that enter the collection zone.

Depending upon the feed material used to generate the particles, the desired particles to be collected can be either the magnetically activated particles or the non-magnetically activated particles. Examples of feed material from which the desired particles in the particle stream are considered the magnetically activated particles include, but are not limited to, Ca, Mg, Sr and Ba. In other words, magnetically activated isotopes of such particles are preferably collected over non-magnetically activated isotopes. Examples of feed material from which the desired particles in the particle stream are considered the non-magnetically activated particles include, but are not limited to, Fe, Ni and Nd. In other words, non-magnetically activated isotopes of such particles are preferably collected over magnetically activated isotopes.

### Example

An example of this invention is demonstrated by referring to the FIGURE. According to the FIGURE, a pressure vessel 10 containing carrier gas ejects a carrier gas stream through an aperture 11 toward a mixing zone 20.

A material for separating into particles is placed in a vessel 30, such as an oven, and the vessel heated under conditions effective to vaporize the material and produce a particle stream. The particle stream is ejected into contact mixing zone 20 to contact the carrier gas stream and form a mixed stream of particles and carrier gas.

A second vessel or oven 31 is also shown in the FIGURE. A separate particle stream is ejected in a flow direction countercurrent to that of the particle stream from vessel 30. The two streams are flowed in countercurrent direction toward the mixing zone 20, and at least a portion of the particles in the particle streams are mixed with the carrier gas stream to form the mixed stream of particles and carrier gas.

The mixed gas stream flows downstream toward a collimator or skimmer 40. The collimator further collimates the components of the mixed stream.

The collimated, mixed stream flows downstream toward a magnetic activation zone 50 in which energy is applied to magnetically activate a portion of the particles in the mixed stream. The mixed stream will also contain particles that are not magnetically activated.

Following application of energy to the mixed stream in the magnetic activation zone, the mixed stream then flows downstream to a separation zone 60 in which a magnetic force or field, e.g., as applied by magnets 61, 62, is used to separate the magnetically activated particles from the non-magnetically activated particles. The magnetically activated particles are shown flowing in paths 63, 64 toward magnets 61, 62, respectively. The non-magnetically activated particles continue to pass through the separation zone toward a collection zone 70, which includes a plate 71. The separation zone is maintained at a temperature below that of the melting point of the particles, and the non-magnetically activated particles contact the plate, returning to a solid state for collection.

The principles and modes of operation of this invention have been described above with reference to various exemplary and preferred embodiments. As understood by those of skill in the art, the overall invention, as defined by the claims, encompasses other preferred embodiments not specifically enumerated herein.

1. A process for separating particles, comprising:
providing at least one particle stream;
contacting at least a portion the particles in the particle stream with a carrier gas stream to produce a mixed stream containing the particles and the carrier gas;
magnetically activating a portion of the particles in the mixed stream; and
separating at least a portion of the magnetically activated particles from the mixed stream.

2. The process of claim 1, wherein the provided particle stream is produced by vaporizing a feed material.

3. The process of claim 1, wherein the feed material is a solid material at 0° C. and 1 atmosphere.

4. The process of claim 1, wherein the particles are particles of at least one element having a nuclear number of at least 6 according to the Periodic Table of the Elements.

5. The process of claim 4, wherein, the particles are comprised of at least two isotopes of one element of the Periodic Table, with at least one of the isotopes being susceptible to magnetic activation and at least one isotope not being susceptible to magnetic activation.

6. The process of claim 1, wherein the particle stream has a particle density of at least 10⁵ particles/m³, based on total volume of the particle stream prior to contacting the carrier gas stream.

7. The process of claim 1, wherein at least two particle streams are provided and at least a portion each particle stream contacts the carrier gas to produce the mixed gas stream.

8. The process of claim 1, wherein the feed material is vaporized in at least two different vessels in which at least two particle streams are produced.

9. The process of claim 8, wherein the two particle streams contact the carrier gas stream to produce the mixed gas stream.

10. The process of claim 8, wherein the particle streams are ejected from their respective vessels in countercurrent direction.

11. The process of claim 10, wherein the particle streams are ejected from their respective vessels in countercurrent direction and in a perpendicular orientation relative to the direction of flow of the carrier gas stream.

12. The process of claim 1, wherein the carrier gas stream is comprised of inert gas.

13. The process of claim 12, wherein the inert gas is at least one noble gas.

14. The process of claim 1, wherein the carrier gas stream is supplied from a pressure vessel at a pressure of at least 100 kPa.

15. The process of claim 14, wherein the pressure vessel includes an aperture of from 10 μm to 1,000 μm in diameter, through which the carrier gas is ejected.

16. The process of claim 1, wherein the particles are contacted with a carrier gas stream to produce the mixed stream in a contact zone at a pressure of less than one atmosphere.

17. The process of claim 1, wherein the mixed stream is further treated to increase collimation of the components of the mixed stream as the mixed stream flows downstream.

18. A process for separating particles, comprising:
vaporizing feed material to form at least one particle stream containing particles capable of being magnetically activated and particles not capable of being magnetically activated;
contacting at least a portion the particles in the particle stream with a separate carrier gas stream to produce a mixed stream containing the particles and the carrier gas;
magnetically activating at least a portion of the particles in the mixed stream that are capable of being magnetically activated; and
separating at least a portion of the magnetically activated particles from non-magnetically activated particles in the mixed stream.

19. The process of claim 18, wherein the feed material is a solid material at 0° C. and 1 atmosphere.

20. The process of claim 18, wherein the carrier gas stream contains at least one noble gas.
